(19) United States
(12) Patent Application Publication
(10) Pub. No.: US 2012/0314000 A1
(43) Pub. Date: Dec. 13, 2012

(54) PRE-TREATMENT COMPOSITIONS FOR INKJET PRINTING

(76) Inventors: George Sarkisian, San Diego, CA (US); Ali Emamjomeh, San Diego, CA (US); Blair A. Butler, San Diego, CA (US)

(21) Appl. No.: 13/157,962

(22) Filed: Jun. 10, 2011

(51) Int. Cl. B41J 2/015; C08K 3/16

(52) U.S. Cl. 347/21; 524/436

(57) ABSTRACT

The present disclosure provides for a pre-treatment composition for inkjet printing, comprising: a liquid vehicle, a fixing agent, a non-ionic defoaming surfactant, a surface tension reducing surfactant, and a latex resin having an acid number of less than 20.

### BACKGROUND

Inkjet technology has become more prevalent in high-speed, commercial and industrial printing, in addition to home and office usage. This technology is a non-impact printing method in which an electronic signal controls and directs droplets or a stream of ink that can be deposited on a wide variety of substrates. Current inkjet printing technology involves forcing the ink drops through small nozzles by thermal ejection, piezoelectric pressure or oscillation, onto the surface of a media.

In addition to ink composition, a pre-treatment composition can be applied before an ink composition is established on the print medium in view of improving printing characteristics and attributes of the image. Such pre-treatment composition is often a substantially colorless liquid that interacts with the colorant and/or with polymeric components of the ink composition to thereby precipitate or, otherwise, fix the ink composition to the print media surface. Within the use of such pre-treatment composition, the precipitated colorants tend to deposit on the surface of the print media, which results thus in the enhancement of image quality attributes, such as, for example, good optical density and, also, allow high speed printing.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, a “surface tension reducing surfactant” refers to a surfactant that lowers the surface tension of the composition to allow wetting and leveling of an ink on a substrate surface.

As used herein, “defoaming surfactant” refers to a surfactant that is shear stable.

As used herein, “shear stable” is measured as subjecting a compound or composition to high shear of 3500 rpm in a Waring commercial blender, Model 34BL97, at 60° C. for 3 minutes without noticeable flocculation.

As used herein, “high speed” refers to printing at a rate of at least 50 feet per minute (fpm).

As used herein, “latex” refers to a group of preparations consisting of stable dispersions of polymeric micro-particles dispersed in an aqueous matrix. Additionally, in one aspect, latex resin components can be present, in the composition, in the form of dispersed latex resin particles.

As used herein, “acid number” or “AN” refers to the acid number that has been measured by conductivity titration of the latent acid functions of a latex resin with nitric acid. As an example, the sample is made strongly basic with KOH then is titrated with 1% of HNO₃. The pH and conductivity curves are measured simultaneously.

As used herein, “liquid vehicle,” “vehicle,” or “liquid medium” refers to the fluid in which a colorant can be dispersed or dissolved to form an inkjet ink. Liquid vehicles are well known in the art, and a wide variety of ink vehicles may be used in accordance with embodiments of the present disclosure. Such ink vehicles may include a mixture of a variety of different agents, including without limitation, surfactants, organic solvents and co-solvents, buffers, biocides, viscosity modifiers, sequestering agents, stabilizing agents, anti-kogation agents, and water. Though not part of the liquid vehicle per se, in addition to the colorants, the liquid vehicle can carry solid additives such as polymers, latexes, UV curable materials, plasticizers, salts, etc. Additionally, the term “aqueous liquid vehicle” or “aqueous vehicle” refers to a liquid vehicle including water as a solvent.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Generally, the present inventors have discovered that pre-treatment compositions containing fixing agents can lack shear stability when printed at high speed. However, it has been recognized that the present pre-treatment compositions can provide shear stability when printed at high speeds. Specifically, it has been discovered that the use of a surfactant system in a pre-treatment composition containing a fixing agent and a latex resin having an acid number of less than 20 can provide shear stability while maintaining durable printed images when used in conjunction with an inkjet ink.

In accordance with this, the present pre-treatment compositions can provide durable images when used in conjunction with inkjet ink providing superior image qualities, for example, optical density, chroma, rub resistance, smear resistance, gloss, etc.

Thus, the present disclosure is drawn to pre-treatment compositions, systems, and associated methods. That being understood, it is noted that when discussing the present pre-treatment compositions, systems, and associated methods, each of these discussions can be considered applicable to each of these examples, whether or not they are explicitly discussed in the context of that example. For example, in discussing defoaming surfactant, such a defoaming surfactant can also be used for a method for printing durable images onto print media at high speed, and vice versa.

With this in mind, a pre-treatment composition for high speed printing can comprise a liquid vehicle, a fixing agent, a non-ionic defoaming surfactant, a surface tension reducing surfactant, and a latex resin having an acid number of less than 20.

Generally, the pre-treatment compositions include, as a fixing agent, a polyvalent metal salt. The polyvalent metal salt component can be a divalent or a higher polyvalent metallic ion and anion. In one example, the polyvalent metal salt components can be soluble in water. Examples of polyvalent metallic ions include divalent metallic ions, such as Ca²⁺, Cu²⁺, Ni²⁺, Mg²⁺, Zn²⁺ and Ba²⁺; trivalent metallic ions, such as Al³⁺, Fe³⁺ and Cr³⁺. In some examples, the polyvalent metallic ion can be selected from the group consisting of Ca²⁺, Mg²⁺ or Zn²⁺. In one aspect, the polyvalent metallic ions can be Ca²⁺. Examples of anions that can be used in conjunction with the above polyvalent metallic ions include Cl⁻, I⁻, Br⁻, NO₃⁻ or RCOO⁻ (where R is H or any hydrocarbon chain). In one aspect, the polyvalent metal salt anion can be a chloride (Cl⁻) or acetate (CH₃COO⁻). In another aspect, the polyvalent metal salt can be composed of divalent or polyvalent metallic ions and of nitrate or carboxylate ions. The carboxylate ions can be derived from a saturated aliphatic monocarboxylic acid having 1 to 6 carbon atoms or a carbocyclic monocarboxylic acid having 7 to 11 carbon atoms. Examples of saturated aliphatic monocarboxylic acid having 1 to 6 carbon atoms include formic acid, acetic acid, propionic acid, butyric acid, isobutyric acid, valeric acid, isovaleric acid, pivalic acid and hexanoic acid.

In one example, the fixing agent can be a polyvalent metal salt selected from the group consisting of calcium chloride, calcium nitrate, magnesium nitrate, magnesium acetate, zinc acetate, and mixtures thereof. In another example, the polyvalent metal salt can be calcium chloride or calcium nitrate (CaCl₂ or Ca(NO₃)₂). In yet another example, the polyvalent metal salt can be calcium chloride (CaCl₂).

Generally, the fixing agent can be present in the pre-treatment composition in an amount representing from about 1 to about 20 wt % of the total weight of the pre-treatment composition. In one aspect, the fixing agent can be present in an amount representing from about 3 to about 15 wt % of the total weight of the pre-treatment composition. In another aspect, the fixing agent can be present in an amount representing from about 5 to about 13 wt % of the total weight of the pre-treatment composition. In yet another aspect, the fixing agent can be present in an amount representing from about 7 to about 9 wt % based on the total weight of the pre-treatment composition.

Generally, the defoaming surfactant can be any surfactant that is shear stable when used in high speed printing processes. In one example, the defoaming surfactant can be a non-ionic silicon surfactant. In one aspect, the defoaming surfactant can include silicone. In another aspect, the defoaming surfactant can be free from silicone. Examples of defoaming surfactants that can be used in the present compositions include, for example, BYK®-012, BYK®021, and BYK®-023 (from BYK Chemie GmbH).

Generally, the defoaming surfactant can be present in an amount representing from about 0.1 wt % to about 1 wt % of the total weight of the pre-treatment composition. In one aspect, the defoaming surfactant can be present in an amount representing from about 0.1 wt % to about 0.5 wt % of the total weight of the pre-treatment composition.

Without intending to be bound by any particular theory, it is believed that, when printed in conjunction with an inkjet ink, the surface tension reducing surfactant of the pre-treatment composition can cause the liquid vehicle of the inkjet ink to become highly wetting and the resulting mixed vehicles quickly penetrate the print media or substrate, leaving the colorants behind. Additionally, it is noted that the pre-treatment composition can be overprinted, underprinted, or concurrently printed with the inkjet ink. However, in one example, the pre-treatment composition can be applied to the print media or substrate prior to the inkjet ink. In one aspect, the print media can be a slow-absorbing non-porous print medium.

Generally, the surface tension reducing surfactant can be any surfactant that lowers the surface tension of an inkjet ink. As such, the selection of the surface tension reducing agent can be dependent upon the inkjet ink with which it is used. In one example, the surface tension reducing agent can be a polyether modified siloxane. Additionally, surface tension reducing surfactants can include, but are not limited to, polyether modified polydimethylsiloxanes having the structure:

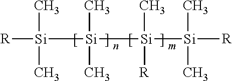

wherein the R groups are functional modifications, such as, for example, BYK®-UV3510 (BYK Chemie GmbH, Wesel, Germany), and BYK®-348 (BYK Chemie GmbH), and 2,5,8,11-Tetramethyl-6-dodecyn-5,8-diol ethoxylates having the structure:

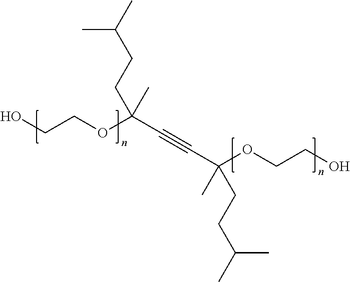

including DYNOL™ 604 (Air products); and other non-ionic organic surfactants such as TEGO® WET 510 (Degussa AG).

The surface tension reducing surfactant can be present in an amount representing from about 0.1 wt % to about 2 wt % of the total weight of the pre-treatment composition. In one example, the surface tension reducing surfactant is present in an amount representing from about 0.5 wt % to about 1.5 wt % of the total weight of the pre-treatment composition.

Generally, the surface tension reducing surfactant and the defoaming surfactant can be present such that, when printed on a print media or substrate, the combination of the surfactants can provide fixing of the ink composition while maintaining shear stability at the printing speed. In one example, the pre-treatment composition can be shear stable when coated onto a substrate at a rate of 400 feet per minute (fpm). Additionally, the present compositions can have a ratio of the surface tension reducing surfactant to defoaming surfactant from about 1:1 to about 10:1 by weight. In one aspect, the ratio can be from about 1:1 to about 5:1 by weight. In another aspect, the ratio can be from about 1:3 to about 1:6.

Generally, the pre-treatment compositions include latex resin components. In some examples, the polymeric latex is a cationic, an anionic or an amphoteric polymeric latex. In one example, the pre-treatment composition can contain an anionic latex resin component having low acid number. As such, in one example, the latex resin can have an acid number of less than 20. In another example, the latex resin can have an acid number of less than 18.

In some examples, the latex resin can be a resin made of polymer and/or copolymer selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers, acrylonitrile-butadiene polymers or copolymers. In other examples, the latex resin component can be latex containing particles of a vinyl acetate-based polymer, an acrylic polymer, a styrene polymer, a styrene-butadiene rubber (SBR)-based polymer, a polyester-based polymer, a vinyl chloride-based polymer, or the like. In yet other examples, the latex resin can be a polymer or a copolymer selected from the group consisting of acrylic polymers, vinyl-acrylic copolymers and acrylic-polyurethane copolymers.

In some examples, the latex resin particles may have an weight average molecular weight (M_{w}) of 5,000 to 500,000. In one example, the latex resins can have an M_{w} ranging from 150,000 to 300,000. In another example, the latex resins can have an M_{w} of about 250,000.

Typically, the average particle diameter of the latex resin particles can be from 10 nm to 1 μm and, in one example, from 10 to 500 nm, and in another example, from 50 nm to 250 nm. The particle size distribution of the latex is not particularly limited, and either latex having a broad particle size distribution or latex having a mono-dispersed particle size distribution may be used. It is also possible to use two or more kinds of polymer fine particles each having a mono-dispersed particle size distribution in combination.

In some examples, the glass transition temperature (Tg) of the resin latex can range from −30° C. to 70° C. and, in one example, can range from 0° C. to 50° C. In another example, the glass transition temperature of the resin latex can be below 40° C. In still another example, the glass transition temperature of the resin latex can be below 30° C. The way of measuring the glass transition temperature (Tg) parameter is described in, for example, Polymer Handbook, 3rd Edition, authored by J. Brandrup, edited by E. H. Immergut, Wiley-Interscience, 1989.

In some examples, the latex resin of the present disclosure can have an acid number of less than 20 and can have a glass transition temperature that is below 40° C. In some other embodiments, the pre-treatment composition can include an anionic latex resin with an acid number below 20, with a glass transition temperature that is below 40° C. and with an M_{w} of about 250,000.

In some examples, the latex resin can be present in the pre-treatment composition in an amount representing from about 1 to about 70 wt % of the total weight of the pre-treatment composition. In one example, the latex resin can be present in an amount representing from about 10 to about 60 wt % of the total weight of the pre-treatment composition. In another example, the latex resin can be present in an amount representing from about 20 to about 50 wt % of the total weight of the pre-treatment composition.

The latex resin may include, but is in no way limited to, latex resin sold under the name Hycar® or Vycar® (from Lubrizol Advanced Materials Inc.); Rhoplex® (from Rohm & Hass company); Neocar® (from Dow Chemical Comp); Aquacer® (from BYC Inc) or Lucidene® (from Rohm & Haas company).

Generally, the pre-treatment compositions can have a viscosity within the range of about 1.0 cps to about 2000 cps, and, in one example, of about 10 cps to about 1000 cps. In another example, pre-treatment compositions can have a viscosity within the range of about 40 cps to about 100 cps as measured at 25° C., in order to achieve the desired rheological characteristics. As noted herein, the viscosity of the composition can be conveniently regulated, for instance, by suitable choice of the quantity and the molecular weight of the resins, organic solvents, and other agents.

In another example, a method for printing durable images onto a print medium at high speed can comprise applying a pre-treatment composition onto the print medium, wherein the pre-treatment composition comprises a liquid vehicle, a fixing agent, a non-ionic defoaming surfactant, a surface tension reducing surfactant, and a latex resin having an acid number of less than 20. The method also includes applying an ink composition onto the print medium having the pre-treatment coating composition applied thereto, wherein the ink composition comprises an aqueous liquid vehicle and a colorant.

In one aspect, the printing speed can be high speed. In one specific aspect, the printing speed can be 400 feet per minute (fpm). Generally, the pre-treatment composition can be applied onto the print medium using coating devices and the ink composition can be jetted onto the print medium via inkjet nozzles. In one example, the time interval between the finishing point of the application of the pre-treatment composition on the print medium and between the starting point of applying the ink composition can be between 0.0001 seconds and 80 seconds. As discussed herein, the pre-treatment composition can be shear stable at a high speed printing, including in one example, a high speed printing of at least 400 feet per minute (fpm).

Further, a system for high speed printing can comprise a pre-treatment composition including any of those described herein, an inkjet ink including an aqueous liquid vehicle and a colorant, and a high speed printer adapted to apply the pre-treatment composition and jet the inkjet ink at a speed of at least 50 feet per minute (fpm). Notable, the high speed printer can include printers capable of printing at speeds of 100, 400, or even up to 2000 fpm.

The coater is not particularly limited and can be appropriately selected from known coaters according to the intended use. Examples of coater include an air doctor coater, a blade coater, a rod coater, a knife coater, a squeeze coater, an impregnation coater, a reverse roll coater, a transfer roll coater, a gravure coater, a kiss-roll coater, a cast coater, a spray coater, a curtain coater, and an extrusion coater. In one example, the coater can be a transfer roll coating device. In order to apply the pre-treatment composition to the recording medium with a uniform thickness, an air-knife may be used for the coating or a member having an acute angle may be positioned with a gap corresponding to the predetermined amount of pre-treatment composition, between the member and the recording medium.

In other examples, the application of the pre-treatment composition may be done by any known commercial methods such as gravure, inkjet method, spray coating method, and roller coating method. In one example, the pre-treatment composition can be applied by a coating method using rollers. Thus, as an example, the pre-treatment composition is rolled on recording medium using commercial roll coating equipment. Exemplary method for printing durable inkjet ink images onto a recording medium includes thus applying the pre-treatment composition onto the recording medium with rollers or transfer roll coating devices. In some examples, a set of more than 3 rollers can be used. In other examples, the printing method can use about up to 30 rollers.

As an example, the pre-treatment composition can be received onto a first surface, and then a contact is formed between the first surface and a transfer roll. The pre-treatment composition can then be transferred from the first surface to the transfer roll. Finally, the pre-treatment composition can be transferred from the transfer roller to a print medium. In one approach, the pre-treatment composition can be applied to a print recording medium just before the printing of inks by printheads. According to this method, one or several rollers receive the pre-treatment composition and transfer it to a print medium. Thereafter, the print media receives inkjet ink from one or more inkjet printheads.

The present pre-treatment compositions described herein can be used with various inkjet inks as known in the art including those having a liquid vehicle and a colorant.

Non-limiting examples of suitable components for the ink liquid vehicle include water-soluble polymers, anionic polymers, surfactants, solvents, co-solvents, buffers, biocides, sequestering agents, viscosity modifiers, surface-active agents, chelating agents, resins, and/or water, and/or combinations thereof.

Suitable solvents for the ink liquid vehicle include, but are not limited to glycerol polyoxyethyl ether, tripropylene glycol, tetraethylene glycol, 1-(2-hydroxyethyl)-2-imidazolidinone, 1-(2-hydroxyethyl)-2-pyrrolidone, 1,6-hexanediol, 1,2,6-hexanetriol, trimethylolpropane, dipropylene glycol, Dantocol® DHE (Lonza Inc., Fairlawn N.J.), and/or combinations thereof. Inks used in combination with the pre-treatment composition having at least the amine-N-oxide and the acid therein may include one or more of the following solvents: ethylene glycol, diethylene glycol, triethylene glycol, or 1-propoxy-2-propanol. In a non-limiting example, the solvents are present in the ink liquid vehicle in an amount ranging from about 1 wt % to about 25 wt %. In another non-limiting example, the solvents are present in the ink liquid vehicle in an amount ranging from about 5 wt % to about 20 wt %. In still another non-limiting example, the solvents are present in the ink liquid vehicle in an amount ranging from about 8 wt % to about 18 wt %. The amount and type of solvent used depends, at least in part, on the desirable properties of the ink. As such, the amounts may vary as desired. In some examples, a single solvent is used in the ink liquid vehicle of one or more of the colored inks. Examples of such solvents include, but are not limited to tripropylene glycol, tetraethylene glycol, or 1-(2-hydroxyethyl)-2-pyrrolidone. In other examples, the inks can include a mixture of two or more of the previously listed solvents.

In some examples, the total weight percent of the solvent mixture ranges from about 7 wt % to about 22 wt %. In other examples, the total weight percent of the solvent mixture ranges from about 12 wt % to about 17 wt %. In still other examples, the total weight percent of the solvent mixtures ranges from about 6 wt % to about 15 wt %.

In some examples, the ink composition can include water. In one aspect, water can be used as the ink carrier for the composition and is part of the liquid vehicle. In other examples, the water can make up the balance of the ink composition, and may be present in an amount representing from about 40 to about 90 weight percentage or representing from about 50 to about 80 weight percentage by weight of the total composition.

The surfactants for the ink liquid vehicle are generally nonionic or anionic. Suitable nonionic surfactants include, but are not limited to ethoxylated alcohols, fluorinated surfactants, 2-diglycol surfactants, and/or combinations thereof. Specific examples of nonionic surfactants include surfactants from the Surfynol® series (e.g., Surfynol® CT211, Surfynol® SEF), manufactured by Air Products and Chemicals, Inc., in addition to the surfactants (e.g., Tergitol®) provided hereinabove for the aqueous vehicle of the fixer. Non-limiting examples of suitable anionic surfactants for the ink vehicle include those anionic surfactants of the Dowfax® family (e.g., Dowfax® 8390), manufactured by Dow Chemical Company, located in Midland, Mich., or anionic Zonyl® surfactants (e.g., Zonyl® FSA), manufactured by E.I. DuPont de Nemours and Company; phosphate ester surfactants including the surfactants of the Emphos® series and the DeDophoS® series, both manufactured by Witco Corp., Middlebury, Conn., the surfactants of the Hostaphat® series, manufactured by Clariant GmbH, Frankfurt, Germany, the surfactants of the ESI-Terge® series, manufactured by Cook Composites and Polymers Co., Kansas City, Mo., the surfactants of the Emulgen® series, manufactured by Kao Specialties Americas LLC, High Point, Nalco, the surfactants of the Crodafos® series, manufactured by Croda Inc., Edison, N.J., the surfactants of the Dephotrope® series and of the DePHOS® series, both manufactured by DeForest Enterprises Inc., Boca Raton, Fla.; alkyl sulfates (e.g., lauryl sulfate), alkyl ether sulfates (e.g., sodium laureth sulfate); N-lauroyl sarcosinate; dodecylbenzene sulfonate; and/or combinations thereof. In some examples, the ink liquid vehicle can include one or more surfactants present in an amount up to about 8 wt %, with other non-limiting examples including from about 0.1 wt % to about 6 wt % and from about 1.2 wt % to about 2 wt %).

In some embodiments, the ink liquid vehicle can include a polymer present in an amount ranging from about 0.01 wt % to about 4 wt %. In other examples, the ink liquid vehicle can include at least one polymer present in an amount ranging from about 0.1 wt % to about 1.5 wt %. The polymers for the ink vehicle are generally water-soluble, and may be selected from those of the salts of styrene-(meth)acrylic acid copolymers, polystyrene-acrylic polymers, polyurethanes, and/or other water-soluble polymeric binders, and/or combinations thereof. Non-limiting examples of suitable polyurethanes include those that are commercially available from Dainippon Ink & Chem., Inc. (DIC), located in Osaka, Japan.

As a non-limiting example, one class of polymeric binders suitable for use in the ink includes salts of styrene-(meth)acrylic acid copolymers. A salt of a styrene-(meth)acrylic acid copolymer includes at least a styrene skeleton and a skeleton of the salt of the styrene-(meth)acrylic acid copolymer in its structure. It may also contain a skeleton derived from a monomer having another unsaturated group, such as a (meth)acrylate skeleton, in its structure. Suitable non-limiting examples of styrene-(meth)acrylic acid copolymers are commercially available and may be selected from the Joncryl® series (e.g., Joncryl® 586 and 683), manufactured by BASF Corp. located in Florham Park, N.J.; SMA-1000Na and SMA-1440K, manufactured by Sartomer, located in Exton, Pa.; Disperbyk 190, manufactured by BYK Chemicals, located in Wallingford, Conn.; polystyrene-acrylic polymers manufactured by Gifu Shellac, located in Japan; or combinations thereof.

Additives may also be incorporated into embodiments of the ink vehicle for the inks. As a non-limiting example, bactericides, such as Proxel® GXL, may be added to the ink to protect the ink from bacterial growth. Other suitable additives include, but are not limited to, buffers, biocides, sequestering agents, chelating agents, or the like, or combinations thereof. In some examples, the ink vehicle includes one or more additives present in an amount ranging from about 0.1 wt % to about 0.5 wt %. In other examples, no additives are present.

The inks are generally prepared by combining the solvents, the surfactants, any additives, and water, and adjusting the pH as desired, in one example, to a basic pH. In other examples, the pH of the ink can range from about 7.0 to about 11. In yet other examples, the pH of the ink can range from about 8.5 to about 9.5. Colorants and polymers can then be added to form the ink compositions.

### EXAMPLES

The following examples illustrate a number of variations of the present compositions, methods, and systems that are presently known. However, it is to be understood that the following are only exemplary or illustrative of the application of the principles of the present compositions, methods, and systems. Numerous modifications and alternative compositions, methods, and systems may be devised by those skilled in the art without departing from the spirit and scope of the present compositions and methods. The appended claims are intended to cover such modifications and arrangements. Thus, while the present compositions, methods, and systems have been described above with particularity, the following examples provide further detail in connection with what are presently deemed to be acceptable.

Ingredients and Abbreviations
Chemguard S550 is a 50%-active short-chain perfluoro-based ethoxylated nonionic fluorosurfactant.
BYK®-348 is a polyether modified siloxane available from BYK Chemie GmbH.
BYK®-021 is a mixture of polysiloxanes and hydrophobic solids available from BYK Chemie GmbH.
BYK®-023 is a mixture of polysiloxanes, hydrophobic solids and emulsifiers, available from BYK Chemie GmbH.
BYK®-012 is a mixture of polymers and hydrophobic solids free of silicone available from BYK Chemie GmbH.
BYK®-094 is a mixture of polysiloxanes and hydrophobic solids available from BYK Chemie GmbH.
BYK®-018 is a mixture of polysiloxanes and hydrophobic solids available from BYK Chemie GmbH.
Lucidene®645 is an acrylic urethane polymer available from Rohm & Haas Company.
Surfynol® DF-220 is a mineral oil based defoamer available from Air Products.
Surfynol® DF-70 is a non-silicone defoamer available from Air Products.
Proxel GXL® is a biocide from Arch Chemicals, Inc.

### Example 1

### Comparison of Pre-Treatment Composition and Comparative

A pre-treatment composition and a comparative composition were prepared in accordance with TABLE 1. All percentages are expressed by weight percentage (wt %) based on the total weight of the pre-treatment composition.

TABLE 1

| | Comparative | Pre-treatment |
|---|---|---|
| Component | Composition | Compositions |
| Calcium Chloride, | 7 | 7 |
| anhydrous | | |
| Lucidene 645 ® | 33 | 32 |
| 2-Pyrrolidone | 3 | 3 |
| Chemguard S550 | 0.1 | — |
| BYK ®-348 Surfactant | — | 0.9 |
| Surfynol ® DF-220 | 0.5 | — |
| BYK ®-021 Defoamer | — | 0.2 |
| Proxel GXL ® | 0.1 | 0.1 |
| Water | Up to 100% | Up to 100% |

The comparative composition and the pre-treatment composition of the present disclosure were tested for shear stability by subjecting the compositions to 3500 rpm in a Waring commercial blender, Model 34BL97, at 60° C. for 3 minutes. The pre-treatment composition had no noticeable flocculation while the comparative had significant flocculation with a cottage cheese like texture.

### Example 2

### Shear Stability for Defoamers

Various defoamers were tested for shear stability by subjecting the defoamers to 3500 rpm in a Waring commercial blender, Model 34BL97, at 60° C. for 1 minute. The defoamer compositions were formulated in the same manner as the comparative formulation of Example 1, except the Surfynol® DF-220 was substituted with the defoamers as listed in Table 2 and the Chemguard S550 was removed. The results are shown in Table 2.

TABLE 2

| Defoamer | |
|---|---|
| (0.5 wt %) | Blender (1 minute) |
| Surfynol ® DF-220 | Gel |
| BYK ®-021 | Acceptable |
| BYK ®-023 | Acceptable |
| BYK ®-094 | Gel |
| BYK ®-018 | Foaming |
| BYK ®-012 | Acceptable |
| Surfynol ® DF-70 | Gel |

The Surfynol® DF-220, BYK®-094, and Surfynol® DF-70 defoamers all showed flocculation providing a gel type consistency. BYK®-018 showed substantial foaming. BYK®-021, BYK®-023, and BYK®-012 showed no noticeable flocculation and, as such, were the only shear stable defoamers in this Example.

Based on these results, pre-treatment compositions using BYK®-021, BYK®-023, and BYK®-012 paired with BYK-348 or other polyether modified siloxanes would be expected to provide durable printed images at high speed printing.

While the disclosure has been described with reference to certain examples, those skilled in the art will appreciate that various modifications, changes, omissions, and substitutions can be made without departing from the spirit of the disclosure. It is intended, therefore, that the invention be limited only by the scope of the following claims.

What is claimed is:

1. A pre-treatment composition for inkjet printing, comprising:
a liquid vehicle;
a fixing agent;
a non-ionic defoaming surfactant;
a surface tension reducing surfactant; and
a latex resin having an acid number of less than 20.

2. The pre-treatment composition according to claim 1, wherein the fixing agent is a polyvalent metal salt selected from the group of calcium chloride, calcium nitrate, magnesium nitrate, magnesium acetate, zinc acetate, and mixtures thereof.

3. The pre-treatment composition according to claim 1, wherein the fixing agent is calcium chloride or calcium nitrate.

4. The pre-treatment composition according to claim 1, wherein defoaming surfactant is a non-ionic silicon surfactant.

5. The pre-treatment composition according to claim 1, wherein the defoaming surfactant includes silicone.

6. The pre-treatment composition according to claim 1, wherein the defoaming surfactant is free from silicone.

7. The pre-treatment composition according to claim 1, wherein the surface tension reducing surfactant is a polyether modified siloxane.

8. The pre-treatment composition according to claim 1, wherein a ratio of the surface tension reducing surfactant to defoaming surfactant is from about 1:1 to about 10:1 by weight.

9. The pre-treatment composition according to claim 1, wherein the latex resin has an acid number of less than 18.

10. The pre-treatment composition according to claim 1, wherein the latex resin is a polymer selected from the group of acrylic polymers, vinyl-acrylic copolymers, acrylic-polyurethane copolymers, and mixtures thereof; and has a weight average molecular weight (M_{w}) ranging from 150,000 to 300,000.

11. The pre-treatment composition according to claim 1, wherein the pre-treatment composition is shear stable when coated onto a substrate at a rate of 400 feet per minute (fpm).

12. The pre-treatment composition of claim 1, wherein the fixing agent is present at from about 1 wt % to about 20 wt % of the total weight of the pre-treatment composition; the defoaming surfactant is present at from about 0.1 wt % to about 1 wt % of the total weight of the pre-treatment composition; the surface tension reducing surfactant is present at from about 0.1 wt % to about 2 wt % of the total weight of the pre-treatment composition; and the latex resin is present at from about 10 wt % to about 60 wt % of the total weight of the pre-treatment composition.

13. A method for printing durable images onto a print medium at high speed, comprising:
applying a pre-treatment composition onto a print medium, the pre-treatment composition comprising a liquid vehicle, a fixing agent, a non-ionic defoaming surfactant, a surface tension reducing surfactant, and a latex resin having an acid number of less than 20; and
applying an ink composition onto the print medium with the pre-treatment composition applied thereto, the ink composition comprising an aqueous liquid vehicle and a colorant.

14. The printing method of claim 13, wherein the pre-treatment composition is applied onto the print medium using a coating device and wherein the ink composition is jetted onto the print medium via inkjet nozzles.

15. The printing method of claim 13, wherein the time interval between the finishing point of the application of the pre-treatment composition on the print medium and between the starting point of applying the ink composition is between 0.0001 seconds and 80 seconds.

16. The printing method of claim 13, wherein the pre-treatment composition is shear stable at a high speed printing of at least 400 feet per minute (fpm).

17. The printing method of claim 13 wherein the print medium is a slow-absorbing non-porous print medium.

18. A system for high speed printing, comprising:
a pre-treatment composition including a liquid vehicle, a fixing agent, a non-ionic defoaming surfactant, a surface tension reducing surfactant, and a latex resin having an acid number of less than 20;
an inkjet ink including an aqueous liquid vehicle and a colorant; and
a high speed printer adapted to apply the pre-treatment composition and jet the inkjet ink at a speed of at least 50 feet per minute (fpm).

19. The system of claim 18, wherein the pre-treatment composition is shear stable at a high speed printing of at least 400 feet per minute (fpm).

20. The system of claim 18, wherein defoaming surfactant is a non-ionic silicon surfactant and the surface tension reducing surfactant is a polyether modified siloxane.
